(19) United States
(12) Patent Application Publication
(10) Pub. No.: US 2024/0127226 A1
(43) Pub. Date: Apr. 18, 2024

(54) SYSTEMS AND METHODS FOR USING SINGLE OR MULTI-CHAIN DEPOSIT TOKENS

(71) Applicant: JPMORGAN CHASE BANK, N.A., New York, NY (US)

(72) Inventors: Umar FAROOQ, New York, NY (US); Naveen MALLELA, Singapore (SG); Muh Hwa LEE, Singapore (SG); Sai Murali Krishna VALIVETI, Singapore (SG); Nelli ZALTSMAN, New York, NY (US); Sunil PANT, Singapore (SG); Basak TOPRAK, New York, NY (US); Emma LANDRIAULT, New York, NY (US); Joshua DANIEL, New York, NY (US); Wee Kee TOH, New York, NY (US)

(21) Appl. No.: 18/485,664

(22) Filed: Oct. 12, 2023

Related U.S. Application Data
(60) Provisional application No. 63/379,581, filed on Oct. 14, 2022.

(51) Int. Cl. G06Q 20/36; G06Q 20/10; G06Q 20/38

(52) U.S. Cl. CPC G06Q 20/3674; G06Q 20/10; G06Q 20/389

(57) ABSTRACT

Systems and methods for using single or multi-chain deposit tokens are disclosed. According to an embodiment, a method for deposit tokenization may include: (1) receiving, by a deposit tokenization service for a token issuer and from an authorized party, an instruction for tokenizing an amount of non-tokenized funds in a deposit account; (2) verifying, by the deposit tokenization service, an identity of the authorized party using a verifiable credential; (3) screening, by the deposit tokenization service and using an information oracle, the deposit account and/or the verifiable credential; (4) debiting, by the deposit tokenization service, the deposit account for the amount and crediting the amount to an omnibus account; (5) tokenizing, by the deposit tokenization service, the amount of the non-tokenized funds on a blockchain network as deposit tokens; and (6) crediting, by the deposit tokenization service, a wallet address on the blockchain network with the deposit tokens.

### RELATED APPLICATIONS

This application claims priority to, and the benefit of, U.S. Provisional Patent Application Ser. No. 63/379,581, filed Oct. 14, 2022, the disclosure of which is hereby incorporated, by reference, in its entirety.

### BACKGROUND OF THE INVENTION

### 1. Field of the Invention

Embodiments relate to systems and methods for using single or multi-chain deposit tokens.

### 2. Description of the Related Art

A Deposit Token evidences a demand deposit claim for a fixed amount of fiat cash by the token-holder against the token issuing bank. Deposit token is issued natively on distributed ledgers such as blockchain digital ledgers and may be transferred to other parties.

### SUMMARY OF THE INVENTION

Systems and methods for using single or multi-chain deposit tokens are disclosed. According to an embodiment, a method for deposit tokenization may include: (1) receiving, by a deposit tokenization service for a token issuer and from an authorized party, an instruction for tokenizing an amount of non-tokenized funds in a deposit account; (2) verifying, by the deposit tokenization service, an identity of the authorized party using a verifiable credential; (3) screening, by the deposit tokenization service and using an information oracle, the deposit account and/or the verifiable credential; (4) debiting, by the deposit tokenization service, the deposit account for the amount and crediting the amount to an omnibus account; (5) tokenizing, by the deposit tokenization service, the amount of the non-tokenized funds on a blockchain network as deposit tokens; and (6) crediting, by the deposit tokenization service, a wallet address on the blockchain network with the deposit tokens.

In one embodiment, the screening comprises sanctions screening.

In one embodiment, the method may also include: updating, by the deposit tokenization service, a transaction store with the amount of deposit tokens, wherein the transaction store updates a total number of deposit tokens for the token issuer.

In one embodiment, the blockchain network may be a public blockchain network or a private blockchain network.

In one embodiment, the verifiable credential attests to an identity of the authorized party.

According to another embodiment, a method for transferring deposit token may include: (1) receiving, from a holder of deposit tokens or an authorized party and by a token issuer, an instruction for transferring an amount of deposit tokens from a first wallet address to a second wallet address; (2) verifying an identity of the holder or the authorized party using a verifiable credential; (3) screening, using an information oracle, the first wallet address, the second wallet address, and/or the verifiable credential; (4) transferring the amount of the deposit tokens from the first wallet address to the second wallet address; and (5) storing a transfer event for the transfer in an event store.

In one embodiment, the screening comprises sanctions screening.

In one embodiment, the first wallet address and the second wallet address are on the same blockchain network. The network may be a public blockchain network or a private blockchain network.

In one embodiment, the first wallet address and the second wallet address are on different blockchain networks, and the method may also include: triggering a burn event for the amount of the deposit tokens in the first wallet address; crediting the second wallet address with the amount of the deposit tokens burned from the first wallet address; and updating a transaction store with the deposit tokens, wherein the transaction store updates a total number of deposit tokens for the token issuer.

In one embodiment, the first wallet address and the second wallet address are on different public blockchain networks.

In one embodiment, the first wallet address is on a public blockchain network and the second wallet address is on a private blockchain network, or the first wallet address is on the private blockchain network and the second wallet address is on the public blockchain network.

In one embodiment, 15. The method of claim 7, wherein the verifiable credential attests to an identity of the authorized party.

According to another embodiment, a method for redemption of deposit tokens may include: (1) receiving, from a holder of deposit tokens or an authorized party, a request to instruct the redemption of an amount of deposit tokens from a wallet address on a blockchain network to a banking account; (2) identifying a holder account as a burn account; (3) verifying an identity of the holder or the authorized party using a verifiable credential; (4) using an information oracle, performing screening on the wallet address from where deposit tokens are originating, the bank account, and/or the verifiable credential; (5) transferring the amount of deposit tokens to the holder account; (6) triggering a burn event on the holder account; (7) executing the burn event; and (8) crediting the banking account with the amount of the deposit token by debiting an omnibus account and crediting the banking account.

In one embodiment, the screening comprises sanctions screening.

In one embodiment, the method may also include updating a transaction store with the amount of the deposit tokens, wherein the transaction store updates a total number of deposit tokens for a deposit token issuer.

In one embodiment, the blockchain network comprises a public blockchain network or a private blockchain network.

In one embodiment, the verifiable credential attests to an identity of the holder or the authorized party.

According to another embodiment, a method of applying on-chain transfer controls to support transferability between end token holders of issuing and other institutions is disclosed.

According to another embodiment, a method of interest distribution for deposit tokens may include: (1) receiving a computation of interest on deposit tokens; (2) trigging an interest event in response to interest being received at an omnibus account; (3) instructing a distribution of interests to deposit token smart contracts; and (4) crediting a wallet address with an equivalent amount of deposit tokens for the interest.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for using single or multi-chain deposit tokens according to an embodiment;

FIG. 2 depicts a system for using single or multi-chain deposit tokens according to another embodiment;

FIG. 3 depicts a method for deposit tokenization according to an embodiment;

FIG. 4A depicts a method for transferring deposit tokens on the same blockchain network according to an embodiment;

FIG. 4B depicts a method for transferring deposit tokens between blockchain networks according to an embodiment;

FIG. 5 depicts a method for interest distribution for deposit tokens according to an embodiment;

FIG. 6A depicts a method for direct redemption of deposit tokens according to an embodiment;

FIG. 6B depicts a method for indirect redemption of deposit tokens according to an embodiment;

FIG. 7 depicts an exemplary computing system for implementing aspects of the present disclosure.

### DETAILED DESCRIPTION OF PREFERRED EMBODIMENTS

Embodiments relate to systems and methods for using single or multi-chain deposit tokens.

A deposit token may be a transferable token evidencing a demand deposit claim by the party in possession of the token against the issuing bank for a fiat cash amount. A deposit token, however, is not a Stablecoin. Instead, the demand deposit claim evidenced is an unsecured claim constituting a general liability of the issuing bank with the same credit priority as other deposits held at the issuing bank, which is accounted for in the fractional reserve requirements applicable to the issuing bank in respect of its deposit liabilities of a similar nature.

Deposit token may be issued and transferred on public or private blockchain networks. In order to facilitate transfer on public environments where there may be a desire by an issuing bank to implement controls as to whom the deposit token is transferred, embodiments may enable the deposit token smart contract(s) to work with a verifiable credential, or “VC”, such as a digital identity or an attestation, and/or with data oracles which may validate certain conditions, such as that the wallet address receiving the tokens is not on a sanctions list.

VCs may attest to the identity of a party, such as the party that is receiving the deposit tokens, and may be used to verify the identity of the party. Examples of digital identities and attestations are described in U.S. patent application Ser. No. 16/878,457, filed May 19, 2020, and U.S. Provisional Patent Application Ser. No. 62/850,181, filed May 20, 2019, U.S. Provisional Patent Application Ser. No. 62/976,262 filed Feb. 13, 2020, U.S. Provisional Patent Application Ser. No. 63/126,335 filed Dec. 16, 2020, and U.S. patent application Ser. No. 17/174,650 filed Feb. 12, 2021, the disclosures of which are hereby incorporated, by reference, in their entireties. Examples of VC verification processes are disclosed in U.S. patent application Ser. No. 18/342,450. filed Jun. 27, 2023, U.S. Provisional Patent Application Ser. No. 63/367,115, filed Jun. 27, 2022, U.S. Provisional Patent Application Ser. No. 63/357,511, filed Jun. 30, 2022, and U.S. Provisional Patent Application Ser. No. 63/373,814, filed Aug. 29, 2022, the disclosures of each of which is hereby incorporated, by reference, in its entirety.

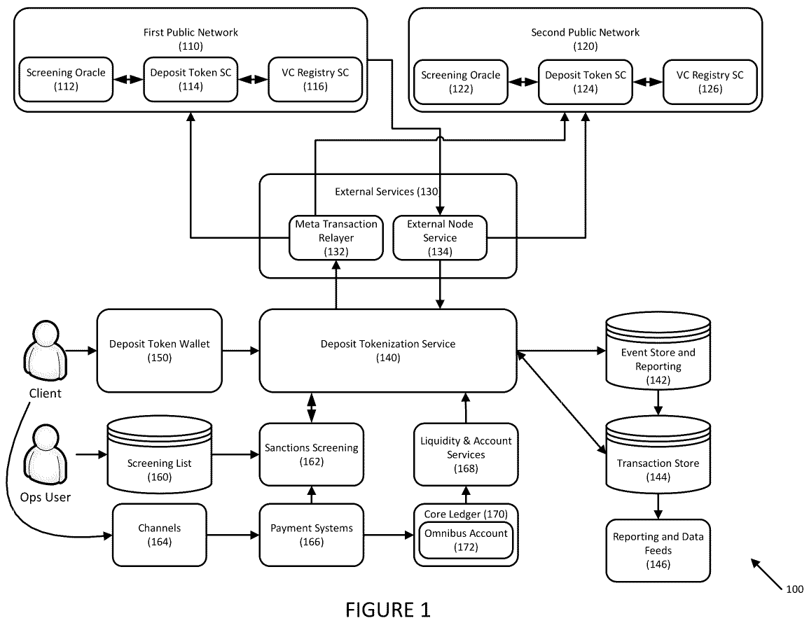

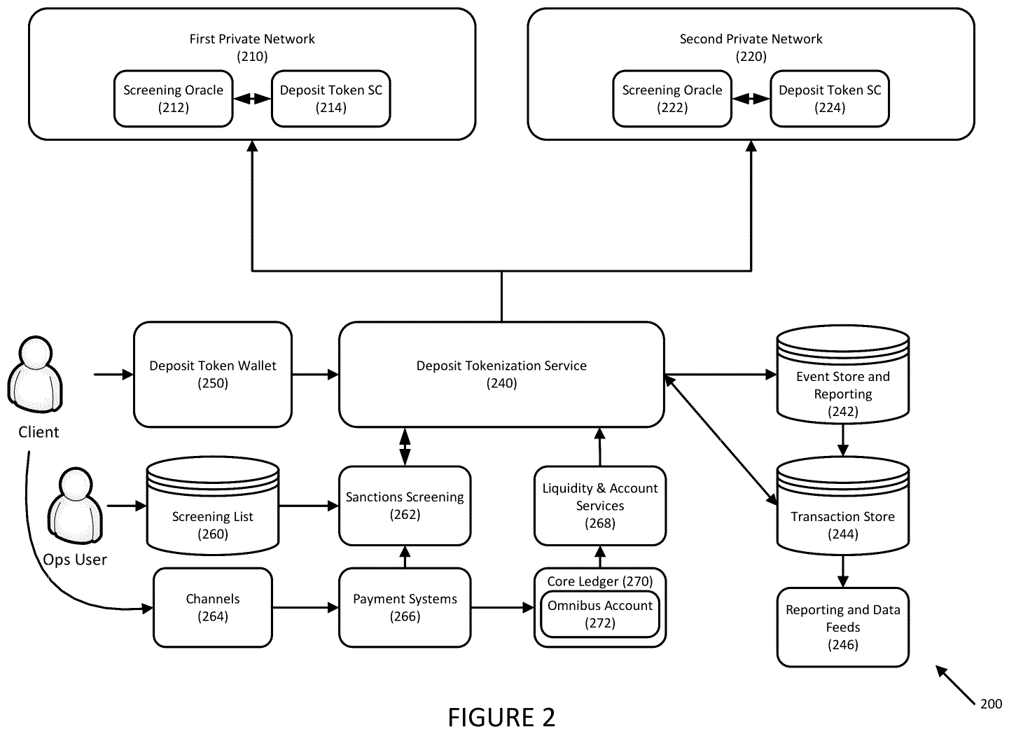

Referring to FIGS. 1 and 2, systems for using single or multi-chain deposit tokens are disclosed according to an embodiment. System 100 depicts one or more public blockchain-based networks (e.g., first public network 110, second public network 120). System 200 depicts one or more private blockchain-based networks (e.g., first private network 110, private public network 120).

First public network 110, second public network 120, first private network 210, and second private network 220 may include screening oracles 112, 122, 212, 222 and deposit token smart contracts (SCs) 114, 124, 214, 224. First public network 110 and second public network 120 may further include verifiable credential (VC) registry smart contracts (SCs) 116, 126.

Deposit Token smart contracts 114, 124, 214, 224 may call additional smart contracts (not shown) that may be created by the token issuer or external parties to apply logic to limit transferability or apply controls to transferability for transfers between end holders of tokens of internal and external institutions.

Screening oracles 112, 122, 212, 222 may be data oracles that may interact with other data oracles (not shown), such as OFAC/sanctions list providers that indicate if a wallet or a verified credential is sanctioned. Screening oracles 112, 122, 212, and 222 may be on-chain smart contracts that may be updated with off-chain activities. Screening oracles 112, 122, 212, and 222 may maintain the same list of activities as screening list 160, 260, which are off-chain.

A “verifiable credential” is a digital identity tool that may be used to verify the identity of party receiving deposit tokens. A deposit token smart contract (not shown) may interact with VC registry smart contracts 116, 126 as part of the transfer validation process to validate the transferability of the deposit tokens and/or the credentials of the entities involved in the transfer.

VCs may also be used to furnish specific proofs that are needed to meet transaction controls requirements such as sanction screening status validation, know your customer (KYC) status, type of institution transacting, etc.

VC registry smart contracts 116, 126 and screening oracles 112, 122, 212, 222 may be optional depending on the network type (e.g., public versus private), the preferences of the deposit token issuer, etc.

External services 130 may provide an interface between first public network 110/second public network 120 and deposit tokenization service 140. It may provide meta transaction relayer 132 and external service node 134. Meta transaction relayer 132 may be a relayer that may pay the gas fee and submit the transaction on behalf of a financial institution.

External service node 134 may allow distributed applications for a financial institution to connect to the node service providers to monitor contract activities on first public network 110 and/or second public network 120.

Deposit token wallet 150, 250 which may be VC enabled, may store deposit tokens for a client.

Deposit tokenization service 140, 240 may create tokens for fiat currency. It may further validate the account(s) involved or client for sanctions and other issues using sanction screening module 162, 262. Sanctions screening module 162, 262 may validate the account(s) and client based on screening list 160, 260. Screening list 160, 260 may be provided with information by one or more operations user.

A client may interface with deposit token wallet 150, 250 and channels 164, 264. Channels 164, 264 may be a method over which the client may provide instructions, such as tokenization instructions, to a financial institution, such as an Application Programming Interface (API), a web user interface (UI), an application, etc.).

Payment services 166, 266 may be a service provided by a financial institution. Payment services 166, 266 may provide payment orchestration and related processing services. For example, payment services 166, 266 may execute controls for sanction screenings, fraud checks, anti-money laundering, etc.

Liquidity and account services 168, 268 may provide core banking ledger, liquidity reporting, etc.

Core ledger 170, 270 may be an off-chain ledger provided by a financial institution. Core ledger 170, 270 may maintain omnibus account 172, 272, which may be used as an account that may hold fiat currency temporarily during the tokenization and de-tokenization process.

Event store and reporting 142, 242 may receive events from deposit tokenization service 140, 240. It may further interface with other internal systems to pull information in order to meet reporting requirements. For example, it may pull client-level information from static data references to meet end of day reporting requirements, such as total liabilities in deposit tokens per client, total of all types of liabilities per client, etc.

Transaction store 144, 244 may keep track of the total deposit tokens in circulation. It may also track the total token supply per blockchain address (e.g., client positions).

Deposit tokenization service 140, 240 may validate the total value in circulation before new mint activity.

Reporting and data feeds 146, 246 may receive transaction data from transaction store 144, 244 and may provide reports/data feeds to external systems.

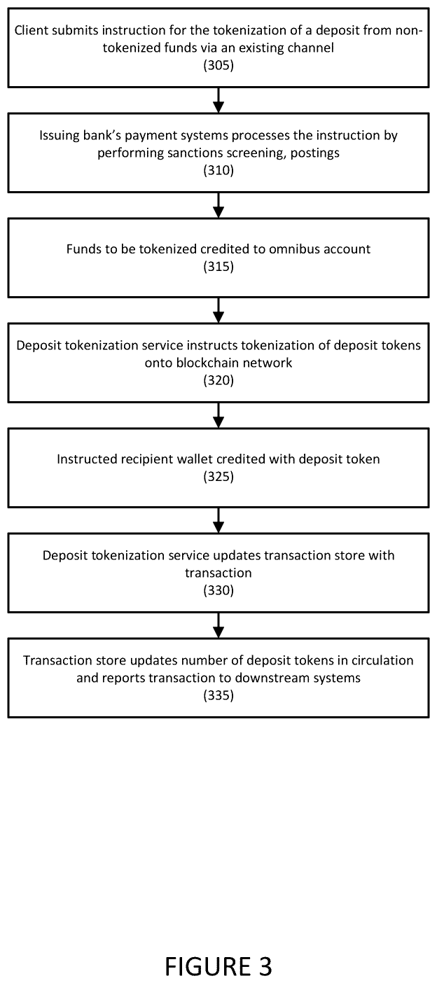

Referring to FIG. 3, a method for deposit tokenization is provided according to an embodiment. In step 305, a client, or an otherwise authorized party, may submit an instruction for the tokenization of a deposit from non-tokenized funds (e.g., taken from a standard account) via an existing channel.

In step 310, the issuing bank's payment systems may process the instruction by performing sanctions screening, postings generation, etc.

In step 315, funds to be tokenized may be credited to an internal omnibus house account for deposit tokens (an “omnibus account”) reflecting the amount of deposit liability to be tokenized. The credit may trigger an event to the deposit tokenization service. The omnibus account may be used in transition; ultimately, the balances may be recorded in the deposit token ledger rather than sitting in the omnibus account.

In step 320, the deposit tokenization service may instruct the tokenization of deposit tokens onto the relevant blockchain network, such as a private or a public blockchain network.

In step 325, the instructed recipient wallet address may be credited with the requested deposit tokens in the applicable blockchain network.

In step 330, the deposit tokenization service may update the transaction store with the transaction, and in step 335, the transaction store may update the total number of deposit tokens for the financial institution and may also provide reports to downstream systems. For example, the deposit tokenization service may keep a state of the total token supply and the placement of the tokens (e.g., (per blockchain address), and may provide state changes to downstream reporting systems.

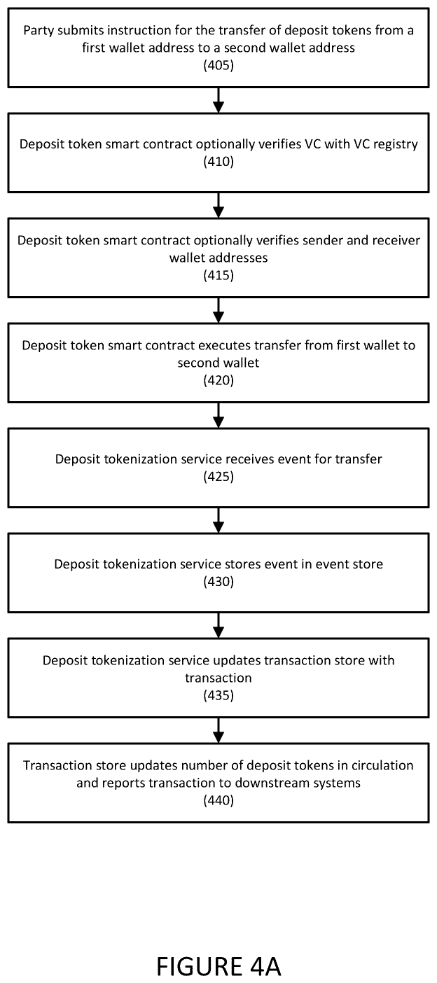

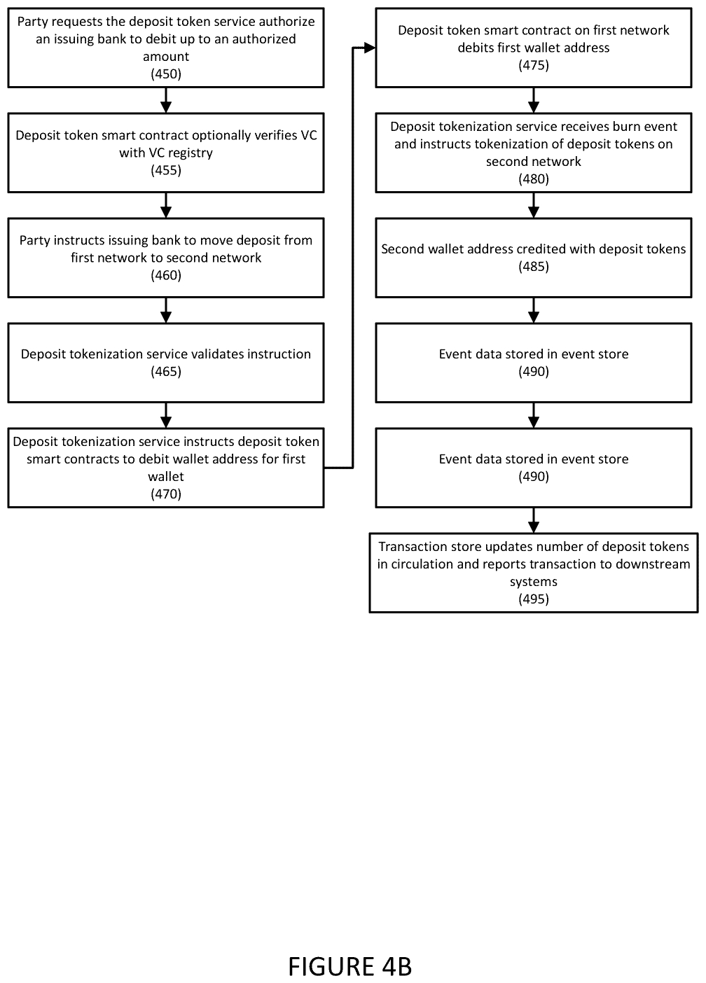

Referring to FIG. 4A, a method for transferring deposit tokens on the same blockchain network is provided according to an embodiment.

In step 405, a party may submit an instruction for the transfer of deposit tokens from one wallet address holding deposit tokens to another wallet address. The instructing party may attach its verifiable credentials (VCs) with the request if required.

In step 410, the deposit token smart contract may optionally verify the VC with a VC registry smart contract and may reject the request if this fails.

In step 415, upon successful verification of VC, deposit token smart contracts may optionally verify the sender and receiver wallet address with a screening oracle. The screening oracle may further check the sender and receiver wallet addresses for sanctions.

In step 420, upon successful validation of the sender and receiver wallet address, the transfer may be executed by a deposit token smart contract.

In step 425, the deposit tokenization service may receive an event for transfer, and in step 430, the event may be stored in an event store.

In step 435, the deposit tokenization service may update the transaction store with the transaction, and in step 440, the transaction store may update the total number of deposit tokens for the financial institution and may also provide reports to downstream systems, such as a FDIC part 370 calculator, end of day anti-money laundering reporting, general ledger reporting, etc.

Referring to FIG. 4B, a method for transferring deposit tokens between blockchain networks is provided according to an embodiment.

In step 450, a client may request that the deposit token service authorize issuing bank to debit up to authorized amount. The issuing bank may generate a proof and respond back to the client. If required, the client may attach the bank given proof and its verifiable credentials (VCs) with the request. In the alternative, the deposit token smart contract may already recognize bank as a party authorized to debit.

In step 455, the deposit token smart contract may optionally verify the VC with a VC registry smart contract, and may reject the request if this fails. The deposit token smart contract may optionally verify the submitted proof and may reject the request if this fails.

In step 460, the client may instruct the financial institution, for example by invoking the deposit token API, to move a deposit balance from one network to other (e.g., from a first network to a second network).

In step 465, the deposit tokenization service may validate the instruction. The issuer's payment systems may process the instruction and may execute the instruction by performing sanctions screening and other required validations.

In step 470, upon successful validation, the deposit tokenization service may instruct the deposit token smart contract on the first network to debit the wallet address from which deposit tokens are being sent and burn the amount.

In step 475, the deposit token smart contract on the first network (the network from which deposit tokens are being sent) may debit the originating wallet address and burn the amount and emits an event.

In step 480, the deposit tokenization service may receive the burn event and the deposit tokenization service may instruct the tokenization of deposit tokens onto the relevant receiving blockchain network (e.g., the second network). In one embodiment, the deposit tokenization service may call a deposit token smart contract on the receiving blockchain network to perform the tokenization.

In step 485, the receiving wallet address may be credited with the requested deposit tokens in the applicable blockchain network (e.g., the second network for this example). For example, the deposit token smart contract on the receiving blockchain network may credit the receiving wallet address with the deposit tokens.

In step 490, deposit tokenization service may store the event in an event store.

In step 495, the deposit tokenization service may update the transaction store with the transaction, and the transaction store may update the total number of deposit tokens for the financial institution and may also provide reports to downstream systems.

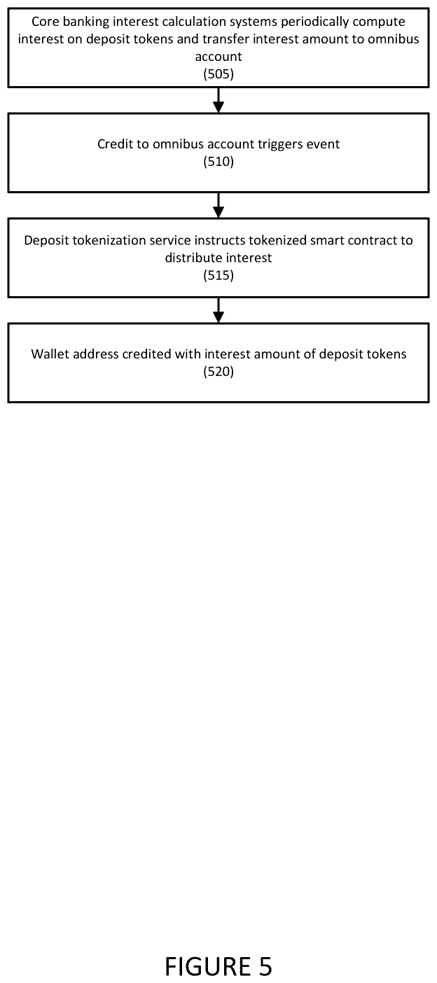

Referring to FIG. 5, a method of interest distribution for deposit tokens is provided according to an embodiment.

In step 505, core banking interest calculation systems may periodically compute interest on deposit tokens in the relevant network, and may transfer the interest amounts to be distributed to an omnibus account from funds of the deposit token issuer.

In step 510, upon credit of funds to the omnibus account, an event may be triggered to the deposit tokenization service.

In step 515, the deposit tokenization service may instruct the distribution of interests to deposit token smart contracts on the relevant network.

In step 520, the wallet addresses on the relevant network holding the deposit tokens to which interest has accrued may be credited with an equivalent amount of deposit tokens.

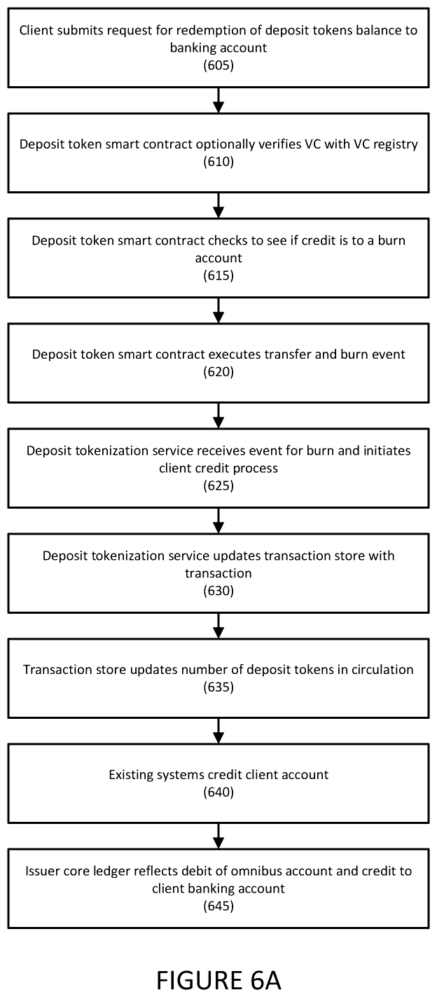

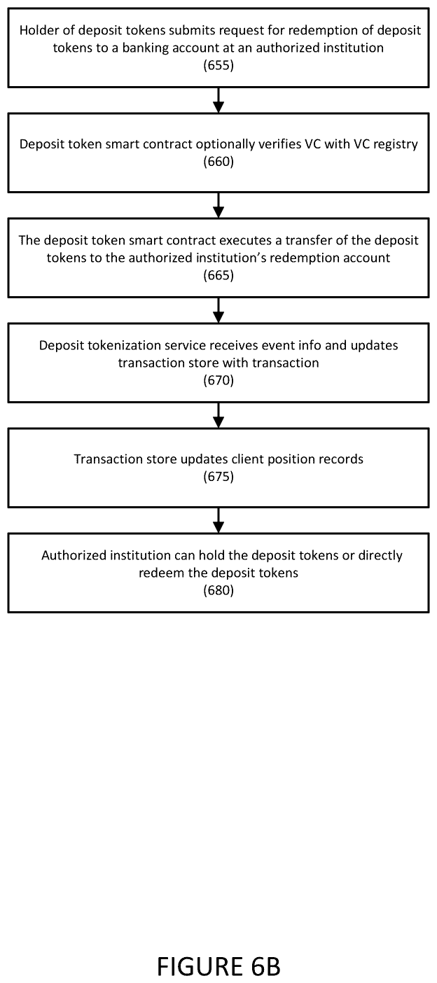

Referring to FIG. 6A, a method for direct redemption of deposit tokens is provided according to an embodiment.

In step 605, a client of the deposit token issuing bank, or other authorized party, may submit a request to instruct the redemption of deposit token balance from an eligible digital wallet on a blockchain network to a banking account. The recipient wallet may be identified as a specific “burn account” as defined by the deposit token issuer. The instructing party may optionally attach its VCs with the request.

In step 610, the deposit token smart contract may optionally verify the VC with VC registry and rejects the request if this fails.

In step 615, upon successful verification of VC, the deposit token smart contracts may check if the credit is to a burn account.

In step 620, the transfer may be executed by the deposit token smart contract and a burn event is emitted by the smart contract.

In step 625, the deposit tokenization service may receive the burn event and triggers the client credit process. This reduces the total number of tokens in circulation.

In step 630, the deposit tokenization service may update the transaction store with transaction, and in step 635, the transaction store may update the number of deposit tokens in circulation. The transaction store may also perform any reporting to downstream systems as needed.

In step 640, a credit to client banking account may be triggered by existing systems.

In step 645, the issuer core ledger may reflect the debit of Omnibus Account and credit to the client banking account.

Referring to FIG. 6B, a method for indirect redemption of deposit tokens is provided according to an embodiment. In this embodiment, the holder of the deposit tokens is not a customer of the issuing bank.

In step 655, a holder of deposit tokens may submit a request for redemption of deposit tokens to a banking account at an authorized institution. In one embodiment, the holder may not be a customer of the deposit token issuing bank. The request may be to a request to redeem a deposit token balance from an eligible digital wallet on a blockchain network to the banking account.

In step 660, the deposit token smart contract may optionally verify the VC with VC registry and rejects the request if this fails.

In step 665, the deposit token smart contract may execute a transfer to the authorized institution's redemption account.

In step 670, the deposit tokenization service may receive event information and may update the transaction store with transaction information. In step 675, the transaction store may update client position records and the number of deposit tokens in circulation. The transaction store may also perform any reporting to downstream systems as needed.

In step 680, once the deposit tokens are received, the authorized institution may hold the deposit tokens by transferring the deposits out of the burn account to its blockchain address, or it may directly redeem the deposit tokens using a process such as that depicted in FIG. 6A.

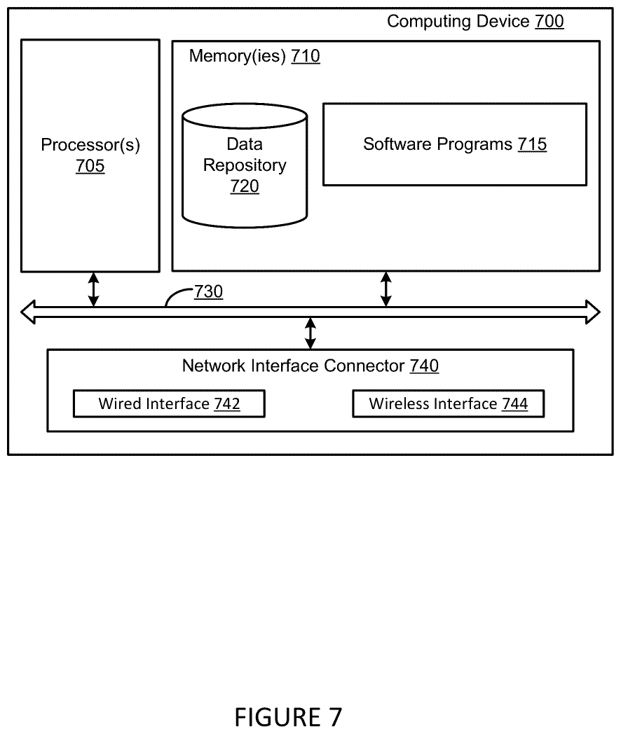

FIG. 7 depicts an exemplary computing system for implementing aspects of the present disclosure. FIG. 7 depicts exemplary computing device 700. Computing device 700 may represent the system components described herein. Computing device 700 may include processor 705 that may be coupled to memory 710. Memory 710 may include volatile memory. Processor 705 may execute computer-executable program code stored in memory 710, such as software programs 715. Software programs 715 may include one or more of the logical steps disclosed herein as a programmatic instruction, which may be executed by processor 705. Memory 710 may also include data repository 720, which may be nonvolatile memory for data persistence. Processor 705 and memory 710 may be coupled by bus 730. Bus 730 may also be coupled to one or more network interface connectors 740, such as wired network interface 742 or wireless network interface 744. Computing device 700 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user. It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for deposit tokenization, comprising:
receiving, by a deposit tokenization service for a token issuer and from an authorized party, an instruction for tokenizing an amount of non-tokenized funds in a deposit account;
verifying, by the deposit tokenization service, an identity of the authorized party using a verifiable credential;
screening, by the deposit tokenization service and using an information oracle, the deposit account and/or the verifiable credential;
debiting, by the deposit tokenization service, the deposit account for the amount and crediting the amount to an omnibus account;
tokenizing, by the deposit tokenization service, the amount of the non-tokenized funds on a blockchain network as deposit tokens; and
crediting, by the deposit tokenization service, a wallet address on the blockchain network with the deposit tokens.

2. The method of claim 1, wherein the screening comprises sanctions screening.

3. The method of claim 1, further comprising:
updating, by the deposit tokenization service, a transaction store with the amount of deposit tokens, wherein the transaction store updates a total number of deposit tokens for the token issuer.

4. The method of claim 1, wherein the blockchain network comprises a public blockchain network.

5. The method of claim 1, wherein the blockchain network comprises a private blockchain network.

6. The method of claim 1, wherein the verifiable credential attests to an identity of the authorized party.

7. A method for transferring deposit token, comprising:
receiving, from a holder of deposit tokens or an authorized party and by a token issuer, an instruction for transferring an amount of deposit tokens from a first wallet address to a second wallet address;
verifying an identity of the holder or the authorized party using a verifiable credential;
screening, using an information oracle, the first wallet address, the second wallet address, and/or the verifiable credential;
transferring the amount of the deposit tokens from the first wallet address to the second wallet address; and
storing a transfer event for the transfer in an event store.

8. The method of claim 7, wherein the screening comprises sanctions screening.

9. The method of claim 7, wherein the first wallet address and the second wallet address are on the same blockchain network.

10. The method of claim 9, wherein the network is a public blockchain network.

11. The method of claim 9, wherein the network is a private blockchain network.

12. The method of claim 7, wherein the first wallet address and the second wallet address are on different blockchain networks, and further comprising:
triggering a burn event for the amount of the deposit tokens in the first wallet address;
crediting the second wallet address with the amount of the deposit tokens burned from the first wallet address; and
updating a transaction store with the deposit tokens, wherein the transaction store updates a total number of deposit tokens for the token issuer.

13. The method of claim 12, wherein the first wallet address and the second wallet address are on different public blockchain networks.

14. The method of claim 12, wherein the first wallet address is on a public blockchain network and the second wallet address is on a private blockchain network, or the first wallet address is on the private blockchain network and the second wallet address is on the public blockchain network.

15. The method of claim 7, wherein the verifiable credential attests to an identity of the authorized party.

16. A method for redemption of deposit tokens, comprising:
receiving, from a holder of deposit tokens or an authorized party, a request to instruct the redemption of an amount of deposit tokens from a wallet address on a blockchain network to a banking account;
identifying a holder account as a burn account;
verifying an identity of the holder or the authorized party using a verifiable credential;
using an information oracle, performing screening on the wallet address from where deposit tokens are originating, the bank account, and/or the verifiable credential;
transferring the amount of deposit tokens to the holder account;
triggering a burn event on the holder account;
executing the burn event; and
crediting the banking account with the amount of the deposit token by debiting an omnibus account and crediting the banking account.

17. The method of claim 16, wherein the screening comprises sanctions screening.

18. The method of claim 16, further comprising:
updating a transaction store with the amount of the deposit tokens, wherein the transaction store updates a total number of deposit tokens for a deposit token issuer.

19. The method of claim 16, wherein the blockchain network comprises a public blockchain network or a private blockchain network.

20. The method of claim 16, wherein the verifiable credential attests to an identity of the holder or the authorized party.
